(19) United States
(12) Patent Application Publication
(10) Pub. No.: US 2020/0307826 A1
(43) Pub. Date: Oct. 1, 2020

(54) DAMPING DEVICE, GIMBAL ASSEMBLY HAVING SAME, AND UNMANNED AERIAL VEHICLE

(71) Applicant: SZ DJI TECHNOLOGY CO., LTD., Shenzhen (CN)

(72) Inventors: Song ZHANG, Shenzhen (CN); Yongsheng ZHANG, Shenzhen (CN); Guibin LIANG, Shenzhen (CN)

(21) Appl. No.: 16/801,892

(22) Filed: Feb. 26, 2020

Related U.S. Application Data
(63) Continuation of application No. PCT/CN2017/099320, filed on Aug. 28, 2017.

(51) Int. Cl. B64D 47/08; B64C 39/02; B64C 1/30; F16M 13/02; F16F 15/02; F16F 13/00

(52) U.S. Cl. CPC B64D 47/08; B64C 39/024; B64C 1/30; F16M 13/022; F16F 15/022; F16F 2224/0208; B64C 2201/027; B64C 2201/108; B64C 2201/127; F16F 2230/0005; F16F 13/00

(57) ABSTRACT

A UAV includes a body, an arm connected to the body, and a gimbal assembly. The gimbal assembly includes a gimbal, a load carried by the gimbal, and a damping device connecting the gimbal to the body. The damping device includes a connection shaft configured to pass through the body, and a first shock-absorbing structure and a second shock-absorbing structure disposed at two ends of the connection shaft, respectively. The first shock-absorbing structure is connected to the body or the arm. The second shock-absorbing structure is connected to the body. One of the first shock-absorbing structure and the second shock-absorbing structure is connected to the gimbal.

### CROSS-REFERENCE TO RELATED APPLICATION

This application is a continuation of International Application No. PCT/CN2017/099320, filed Aug. 28, 2017, the entire content of which is incorporated herein by reference.

### TECHNICAL FIELD

The present disclosure relates to the field of shock-absorbing structures, and in particular, relates to a damping device and a gimbal assembly and an unmanned aerial vehicle (UAV) having the damping device.

### BACKGROUND

In the current gimbal designing, a shock absorbing ball is usually implemented to stabilize photographing. The shock-absorbing ball is generally made of elastic material, which has poor stiffness and is greatly affected by the ambient temperature. Therefore, a combination of multiple shock-absorbing balls is required to meet the shock absorption effect, and the structure is relatively complicated.

### SUMMARY

In accordance with the disclosure, there is provided a UAV. The UAV includes a body, an arm connected to the body, and a gimbal assembly. The gimbal assembly includes a gimbal, a load carried by the gimbal, and a damping device connecting the gimbal to the body. The damping device includes a connection shaft configured to pass through the body, and a first shock-absorbing structure and a second shock-absorbing structure disposed at two ends of the connection shaft, respectively. The first shock-absorbing structure is connected to the body or the arm. The second shock-absorbing structure is connected to the body. One of the first shock-absorbing structure and the second shock-absorbing structure is connected to the gimbal.

### BRIEF DESCRIPTION OF THE DRAWINGS

FIG. 1 illustrates a perspective view of a damping device in some embodiments of the present disclosure;

FIG. 2 illustrates a perspective view of a first shock-absorbing structure in some embodiments of the present disclosure;

FIG. 3 illustrates a perspective view of a partial structure of a damping device in some embodiments of the present disclosure;

FIG. 4 illustrates an exploded view of the first shock-absorbing structure in some embodiments of the present disclosure;

FIG. 5 illustrates an exploded view of a partial structure of the damping device in some embodiments of the present disclosure;

FIG. 6 illustrates an exploded view of a second shock-absorbing structure in some embodiments of the present disclosure;

FIG. 7 illustrates a perspective view of an unmanned aerial vehicle (UAV) in some embodiments of the present disclosure;

FIG. 8 illustrates a perspective view of another UAV in some embodiments of the present disclosure; and

FIG. 9 illustrates a perspective view of another UAV in some embodiments of the present disclosure.

Reference Numerals: 1: body; 2: arm; 201: folding arm; 202: straight arm; 3: photographing device; 301: gimbal; 302: load; 4: damping device; 10: first shock-absorbing structure; 11: first mounting part; 12: first support member; 121: connection rod; 122: first connection bracket; 13: first shock absorber 131: steel wire rope; 132: first damper; 133: first connection head; 1331: first fixation portion; 1332: sleeve portion; 134: second connection head; 1341: second fixation portion; 1342: quick-release member; 135: clamp member; 136: fasteners; 14: sleeve; 141: lock portion; 142: operation portion; 20: second shock-absorbing structure; 21: second mounting portion; 22: second support member; 221: bearing; 222: second connection bracket; 23: second shock-absorbing member; 231: second damper; 232: connection portion; 232a: main body portion; 232b: clamp portion; 30: connection shaft; 5: propeller assembly.

### DETAILED DESCRIPTION OF THE EMBODIMENTS

The following will clearly describe the technical solutions in the embodiments of the present disclosure with reference to the accompanying drawings of the present disclosure. Obviously, the described embodiments are only some of the embodiments of the present disclosure, but not all of the embodiments. Based on the embodiments of the present disclosure, all other embodiments obtained by a person of ordinary skill in the art without creative efforts shall fall within the scope of the present disclosure.

The damping device 4 of the present disclosure, a gimbal assembly and a UAV having the damping device 4 will be described in detail below, with reference to the drawings. When no conflicts exist, the following embodiments and the features of the embodiments may be combined with each other.

At present, the gimbal 301 is mounted on a movable device (such as an unmanned aerial vehicle (UAV)). A load 302 (e.g., camera, image sensor, etc.) mounted on the gimbal 301 may not operate normally due to an impact of a shock. Accordingly, it is needed to make a damping design for the gimbal 301 in order to increase the stability of the load 302.

Further explanation is described below taking the gimbal 301 mounted on the UAV as an example. The gimbal 301 can be disposed on top of or underneath the UAV. The present disclosure refers to a gimbal 301 provided on top of the UAV as an upper mounted gimbal 301, and a gimbal 301 provided underneath the UAV as a lower mounted gimbal 301.

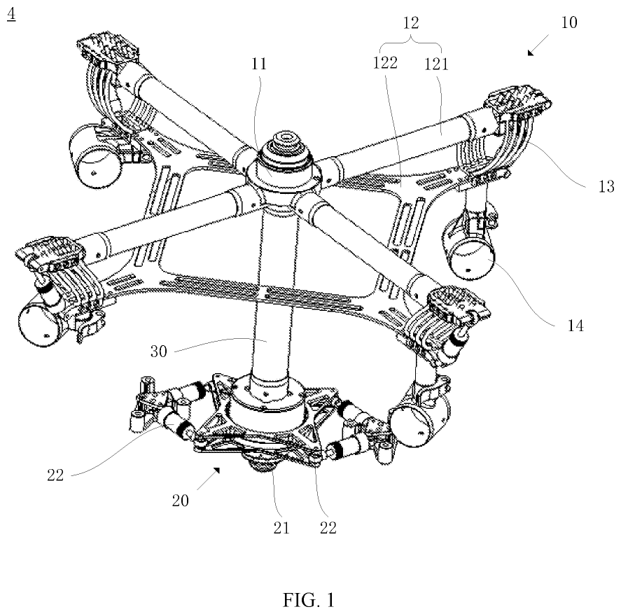

Referring to FIG. 1, some embodiments of the present disclosure provide a damping device 4 (also referred to as a “shock-absorbing device”). The damping device 4 may include a connection shaft 30, a first shock-absorbing structure 10 and a second shock-absorbing structure 20. The connection shaft 30 is configured to pass through the body 1 of the UAV. The first shock-absorbing structure 10 and the second shock-absorbing structure 20 are respectively disposed at two ends of the connection shaft 30, combining the first shock-absorbing structure 10 and the second shock-absorbing structure 20 together by the connection shaft 30, so that the first shock-absorbing structure 10 and the second shock-absorbing structure 20 can be arranged respectively on top of and underneath the UAV.

The first shock-absorbing structure 10 is connected to a body 1 or an arm 2 of the UAV, and the second shock-absorbing structure 20 is connected to the body 1 of the UAV. One of the first shock-absorbing structure and the second shock-absorbing structure 20 is connected to the gimbal 301, so as to connect the gimbal 301 to the UAV. By arranging the first shock-absorbing structure 10 and the second shock-absorbing structure 20 to be on an upper and a lower levels, respectively, and connecting the gimbal 301 to the UAV by the first shock-absorbing structure 10 or the second shock-absorbing structure 20, to absorb a shock of the gimbal 301, the structure is simple, and a good shock absorbing effect can be achieved, which can meet an upper mounting or a lower mounting of the gimbal 301 on the UAV, and is suitable for the shock absorbing purpose of the gimbal 301 with a heavy load of the UAV.

It should be noted that whether the first shock-absorbing structure 10 is connected to the body 1 or the arm 2 can be set based on a size of the body 1. For example, when the size of the body 1 is relatively large (e.g., a length and a width of the body 1 are each greater than its corresponding preset value), the first shock-absorbing structure 10 may be connected to the body 1 or to the arm 2. When the size of the body 1 is relatively small, the first shock-absorbing structure 10 needs to be connected to the arm 2 to maintain a balance of the UAV.

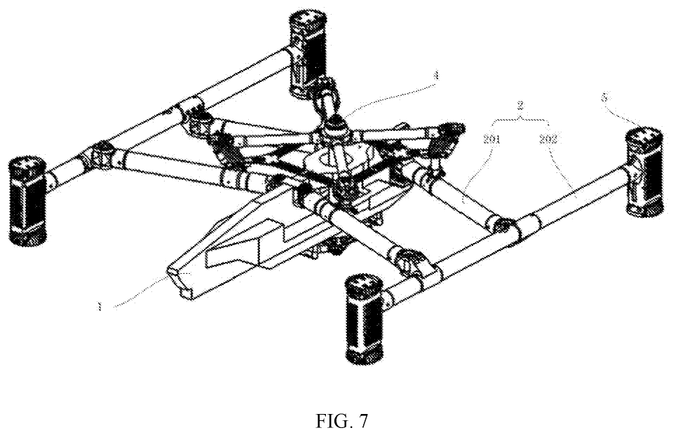

Referring to FIG. 7, a through hole (not labeled) is disposed in the body 1, and the connection shaft 30 passes through the through hole. A diameter of the through hole is larger than a diameter of the connection shaft 30, so that the connection shaft 30 can be easily pulled out of the body 1 to facilitate folding of the UAV in a non-operating state.

Also referring to FIG. 7, the first shock-absorbing structure 10 is located at least partially above the body 1, and a part of the first shock-absorbing structure 10 located above the body 1 is connected to the gimbal 301, to connect the gimbal 301 to the UAV and absorb the shock of the gimbal 301 disposed above the body 1 by a first shock-absorbing structure. In this embodiment, the first shock-absorbing structure 10 is a compression shock-absorbing mechanism, that is, the gimbal 301 is disposed above the first shock-absorbing structure 10, to apply a pressure to the first shock-absorbing structure 10. The first shock-absorbing structure 10 may be configured to provide an elastic supporting force to the connection shaft 30 to counteract an impact of a shock generated during a flight of the UAV on the gimbal 301 disposed above the body 1.

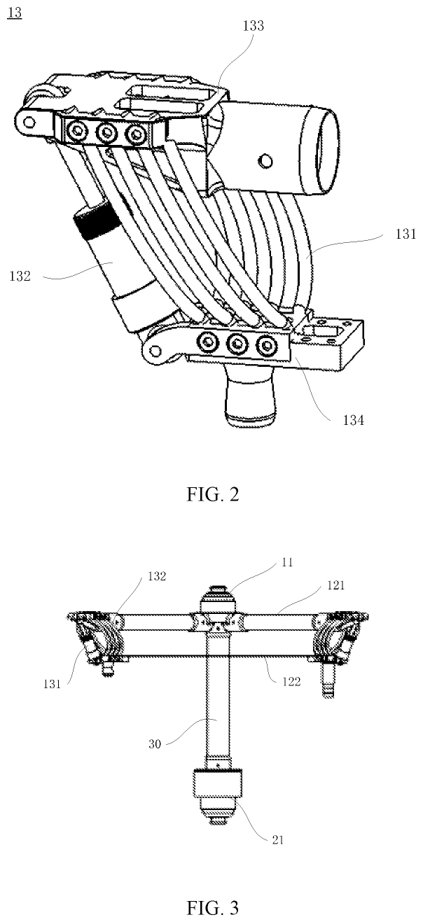

As shown in FIGS. 1 and 2, the first shock-absorbing structure 10 may include a first mounting portion 11, a first support member 12, and a first shock-absorbing member 13. Optionally, the first mounting portion 11 is located above the body 1. Of course, the first support member 12 and the first shock-absorbing member 13 may also be located above the body, so that the first shock-absorbing structure 10 can be conveniently connected to the UAV.

The first mounting portion 11 is configured to connect the gimbal 301, so that the gimbal 301 can be connected to the UAV. Optionally, the gimbal 301 and the first mounting portion 11 are connected in a detachable manner. For example, the gimbal 301 and the first mounting portion 11 are connected by a thread, a snap-fit, or another detachable connecting method, to facilitate dismounting of the gimbal 301 from the UAV.

In addition, the first mounting portion 11 is also connected to the connection shaft 30 to support the first mounting portion 11 by the connection shaft 30. The connecting method between the first mounting portion 11 and the connection shaft 30 can be set based on needs. For example, in one embodiment, the first mounting portion 11 is sleeved on the connection shaft 30 and is fixed to the connection shaft 30 by a thread or other connecting members, which ensures a stability of the first mounting portion 11 and the implementation method is relatively simple. In another embodiment, the first mounting portion 11 may be connected to the connection shaft 30 by snap-fitting or other methods.

The first support member 12 is connected to the first mounting portion 11. Specifically, the first support member 12 is connected to a circumferential side wall of the first mounting portion 11, so that it can be connected to the connection shaft 30 by the first mounting portion 11. The first shock-absorbing member 13 is disposed at an end of the first support member 12 away from the first mounting portion 11, and the first shock-absorbing member 13 is configured to connect the body 1 or the arm 2 of the UAV. The first shock-absorbing member 13 can transmit an elastic supporting force to the connection shaft 30 by the first support member 12, thereby counteracting the shock of the gimbal 301.

Optionally, there are a plurality of first shock-absorbing members 13, configured to correspondingly connect a plurality of arms 2 of the UAV, so as to support the connection shaft 30 at different positions and maintain the stability of the connection shaft, thereby absorbing the shock of the upper mounted gimbal 301. Accordingly, there are also a plurality of first support members 12, that match the plurality of first shock-absorbing members 13. The plurality of first support members 12 are distributed around the first mounting portion 11, and each of the first support members 12 is connected to the arm 2 by the first shock-absorbing member 13. After the gimbal 301 is mounted on the first mounting portion 11, forces generated by the plurality of first shock-absorbing members 13 form a combined elastic force which is applied to the connection shaft 30, thereby preventing the gimbal 301 connected to the first mounting portion 11 from shocking, so that the shock of the gimbal 301 can be absorbed.

The distribution manner of the plurality of first support members 12 may be set based on actual situations, so that the shock absorbing effect of the first shock-absorbing structure 10 can be optimal. For example, the first support members 12 may be evenly distributed around the first mounting portion 11, so that the elastic force formed by the component forces generated by the plurality of first shock-absorbing members 13 is applied to a central axis of the connection shaft 30, thereby counteracting the shock of the gimbal 301.

In this embodiment, the number of the first shock-absorbing members 13 and the number of the first-support members 12 are equal, and the first shock-absorbing members 13 and the first support members 12 are correspondingly matched. The number of the first shock-absorbing members 13 and the number of the first support members 12 can be set based on factors such as a weight of the gimbal 301, a weight of the load 302 mounted on the gimbal 301, the size of the body 1, a number of the arms 2, etc., to maximally counteract the shock of the gimbal, so as to increase the stability of the gimbal. In a specific implementation manner, either of the number of the first shock-absorbing member 13 and the number of the first support member 12 is four, and the four first support members 12 are evenly distributed around the first mounting portion 11 to better counteract the shock of the gimbal 301 and maintain the stability of the gimbal 301.

Referring to FIG. 1, the first support member 12 includes a plurality of connection rods 121 and a first connection bracket 122 arranged at one side of and spaced apart from the plurality of connection rods 121. The plurality of connection rods 121 are connected to the first mounting portion 11, and each connection rod 121 is connected to the first connection bracket 122 by a corresponding first shock-absorbing member 13, thereby combining the plurality of first shock-absorbing members 13 together by the plurality of connection rods 121 and the first connection bracket 122.

The connection manner between the connection rod 121 and the first mounting portion 11 can be set as needed to meet different needs. For example, in one embodiment, the connection rod 121 is movably connected to all the first mounting portion 11, thereby facilitating the user to adjust the position of the connection rod 121. The movable connection may be implemented by a hinge, a sleeve or other movable connection manners.

In another embodiment, the connection rod 121 is connected to the first mounting portion 11 to prevent the connection rod 121 from shaking. Optionally, the connection rod 121 is connected to the first mounting portion 11 in a detachable manner. On the one hand, a fixed connection between the connection rod 121 and the first mounting portion 11 can be achieved to prevent the connection rod 121 from shaking. On the other hand, it is convenient to dismount the connection rod 121 from the first mounting portion 11 so as to facilitate a storage. For example, the connection rod 121 may be fixed to the first mounting portion 11 by a detachable connection manner such as a thread or a pin.

The plurality of connection rods 121 may be formed integrally, or may be disposed separately. The integrally formed connection rod 121 is stronger, and the separated disposed connection rods 121 are more flexible, which facilitates the storage. The integrally formed connection rod 121 or the separately disposed connection rods 121 can be selected based on needs, and are not limited by the present disclosure.

Also referring to FIG. 1, the plurality of connection rods 121 are radially distributed, so that elastic supporting forces are applied to the connection shaft 30 around the first mounting portion 11 to absorb the shock of the gimbal 301 mounted on the first mounting portion 11. Each connection rod 121 may be perpendicular to the connection shaft 30, and the plurality of connection rods 121 are disposed on the same horizontal plane, so that the first shock-absorbing structure 10 can be as symmetrical as possible to better counteract the shock of the gimbal 301. Of course, each connection rod 121 may also form an inclined angle with the connection shaft 30 (that is, the connection rod 121 is not perpendicular to the connection shaft 30), so that the plurality of connection rods 121 are distributed on different planes.

In addition, the first connection bracket 122 of this embodiment is integrally formed. Referring to FIG. 1, a through hole is disposed in the first connection bracket 122, and the connection shaft 30 passes through the through hole, that is, the first connection bracket 122 is a structure arranged along a circumferential direction of the connection shaft 30 to facilitate a coupling of the connection rod 121, the first shock-absorbing member 13 and the first connection bracket 122.

The type of the first shock-absorbing member 13 can be selected according to a direction of the shock. In this embodiment, the first shock-absorbing member 13 includes at least one of: a one-dimensional shock absorber, a two-dimensional shock absorber, or a three-dimensional shock absorber. The one-dimensional shock absorber can provide stiffness and damping along a line, the two-dimensional shock absorber can provide stiffness and damping in a plane (two dimensions), and the three-dimensional shock absorber can provide stiffness and damping in a three-dimensional space (three dimensions).

In a specific implementation manner, the first shock-absorbing member 13 is a composite shock absorber, and may include at least two different types of shock absorbers. In aerial photography by UAVs, the source of the shock comes from all directions of the space. By selecting a composite shock absorber, shock absorption can be provided in all directions of shock absorption, so as to better counteract the shock of the gimbal 301. For example, the first shock-absorbing member 13 may include a one-dimensional shock absorber and a three-dimensional shock absorber. Of course, the first shock-absorbing member 13 may be a composite shock absorber in another combination.

As shown in FIGS. 1 and 2, in this embodiment, the first shock-absorbing member 13 includes a steel wire rope 131 and a first damper 132. The steel wire rope 131 is a three-dimensional shock absorber, and the first damper 132 is a one-dimensional shock absorber. A composite shock absorber is selected to counteract the shocks in different directions.

The steel wire rope 131 and the first damper 132 are connected between the connection rod 121 and the first connection bracket 122. The steel wire rope 131 can provide stiffness in a deformation direction of the steel wire rope 131. The first damper 132 It can provide damping in an axial extension direction. The steel wire 131 and the first damper 132 are combined into a one piece by the connection rod 121 and the first connection bracket 122 to provide an elastic supporting force for the connection shaft 30 to implement a damping function. In a specific implementation, referring to FIG. 3, the steel wire rope 131 and the first damper 132 are both inclinedly connected between the connection rod 121 and the first connection bracket 122.

The plurality of steel wire ropes 131 of the first shock-absorbing member 13 and the plurality of first dampers 132 both extend toward the body 1 of the UAV. A combination of the plurality of first shock-absorbing members 13 can provide stiffness and damping in a vertical downward direction and a horizontal transverse direction. At the same time, because the steel wire rope 131 has stiffness in a radial direction, the combination of the plurality of first shock-absorbing members 13 can also provide stiffness and damping in a horizontal rotation direction, thereby realizing the damping effect to the gimbal 301.

The number and arrangement of the steel wire ropes 131 can be selected based on needs, so that the first shock-absorbing member 13 can provide the elastic supporting force in a preset direction. For example, a plurality of steel wire ropes 131 may be selected to ensure the strength of the first shock-absorbing member 13 and the damping effect on the first shock-absorbing member 13. The plurality of steel ropes 131 may be arranged in one row or multiple rows to meet actual needs. For example, in one embodiment, there may be two rows of the steel ropes 131, the two rows of the steel ropes 131 are disposed opposite to each other, and the oppositely disposed two row of steel wire rope 131 can increase the strength of the first shock-absorbing member 13. Each row of the steel wire ropes 131 includes a plurality of steel wire ropes 131 that are bent in a direction away from the other row of steel wire ropes 131. By bending the steel wire ropes 131, a radial stiffness of the steel wire ropes 131 can meet the requirements, so as to better counteract the shock of the gimbal 301.

A hydraulic viscous damper or another type of damper may be selected as the first damper 132, and the type of the first damper 132 may be selected based on aspects of product reliability, cost, etc.

In this embodiment, by selecting the number and arrangement of the steel ropes 131 and the type of the first damper 132, the stiffness value of the steel rope 131 and the damping value of the first damper 132 can be adjusted, which is good in versatility.

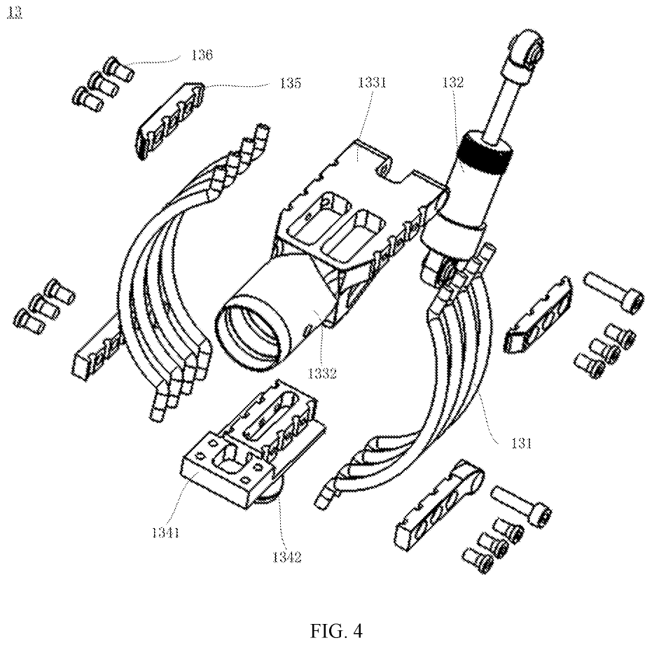

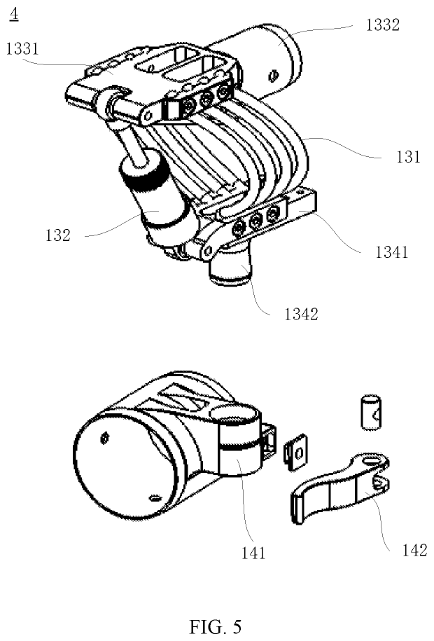

As shown in FIG. 2 and FIG. 4, the first shock-absorbing member 13 may further include a first connection head 133 and a second connection head 134. The steel wire rope 131 and the first damper 132 are each connected to the connection rod 121 by the first connection head 133, and are each connected to the first connection bracket 122 by the second connection head 134. Therefore, the steel wire rope 131 and the first damper 132 are fixed to the connection rod 121 and the first connection bracket 122.

Referring to FIG. 2, one end of the first damper 132 is rotatably connected to the first connection head 133 and the other end is rotatably connected to the second connection head 134 to provide damping in the axial extension direction (an axial direction of the first damper 132). For example, the first connection head 133 and the second connection head 134 may each include a pin (not labeled), and two ends of the first damper 132 respectively pass through the pins of the first connection head 133 and the first connection head 133, to implement a rotatable connection to the first connection head 133 and the second connection head 134.

Referring to FIG. 4, the first connection head 133 may include a first fixation portion 1331 and a sleeve portion 1332. The first fixation portion 1331 may be configured to fix the steel wire rope 131 and the first damper 132, and the sleeve portion 1332 may be configured to sleeve the connection rod 121 so as to be connected to the connection rod 121 by the first fixation portion 1331 and the sleeve portion 1332. The sleeve portion 1332 is disposed to facilitate the detachment of the first connection head 133 from the connection rod 121.

Correspondingly, the second connection head 134 may include a second fixation portion 1341 and a quick-release member 1342 connected to the second fixation portion 1341. The second fixation portion 1341 may be configured to fix the steel wire rope 131 and the first damper 132, and the second fixation portion 1341 is also connected to the first connection bracket 122 so as to connect the steel wire rope 131 and the first damper 132 to the first connection bracket 122 by the second fixation portion 1341. The quick-release member 1342 is connected to the arm 2, so as to connect the first shock-absorbing member 13 to the UAV.

In this embodiment, the first shock-absorbing member 13 is connected to the first fixation portion 1331 and the second fixation portion 1341 in a detachable manner. Specifically, the first shock-absorbing member 13 may further include a plurality of clamp members 135 respectively coupled to the first fixation portion 1331 and the second fixation portion 1341, to fix the steel wire rope 131 to the first fixation portion 1331 and the second fixing part 1341. One end of the steel wire rope 131 is disposed between the first fixation portion 1331 and a corresponding clamp member 135, and the other end is disposed between the second fixation portion 1341 and a corresponding clamp member 135, to fix the steel wire rope 131 by a coupling of the clamp member 135 with the first fixation portion 1331 and the second fixation portion 1341. Referring again to FIG. 2, in a specific implementation manner, the steel wire ropes 131 are in two rows, and each of the first shock-absorbing members 13 includes four clamp members 135. One ends of the two rows of steel wire rope 131 are respectively clamped on both sides of the first fixation portion 1331 by two clamp members 135, and the other ends of the two rows of wire ropes 131 are respectively clamped on both sides of the second fixation portion 1341 by the other two clamp members 135.

Referring again to FIG. 2 and FIG. 4, two through holes configured to allow the steel wire rope 131 to pass through are respectively formed between the first fixation portion 1331 and its corresponding clamp member 135, and between the second fixation portion 1341 and its corresponding clamp member 135. The through holes are configured to accommodate the steel wire rope 131, so that the steel wire rope 131 can be more firmly clamped between the first fixation portion 1331 and its corresponding clamp member 135, and between the second fixation portion 1341 and its corresponding clamp member 135.

Further, the first shock-absorbing member 13 may further include a fastener 136 that fixes the clamp members 135 corresponding to the first fixation portion 1331 and the second fixation portion 1341, to further firmly fix the steel wire rope 131 between the first fixation portion 1331 and its corresponding clamp member 135, and the second fixation portion 1341 and it corresponding clamp member 135.

In addition, after the sleeve portion 1332 sleeves the connection rod 121, the sleeve portion 1332 and the connection rod 121 can be connected by screws, etc., to lock the sleeve portion 1332 and the connection rod 121. The second fixation portion 1341 and the first connection bracket 122 may be connected by screws, etc., or may be directly fixed together by means of snap-fitting, etc., which is not limited by the present disclosure.

The quick-release member 1342 is detachably connected to the arm 2 so that the quick-release member 1342 can be easily removed from the machine arm. Referring to FIG. 5, the damping device 4 may further include a sleeve member 14. The sleeve member 14 is configured to sleeve the arm 2 of the UAV and is movably connected to the quick-release member 1342 to detachably connect the first shock-absorbing member 13 to the arm 2. When the UAV is in a non-operating state, the sleeve member 14 and the quick-release member 1342 can be quickly separated, so that the first shock-absorbing member 13 is dismounted from the arm 2 to facilitate the folding and storage of the UAV.

A lock portion 141 may be disposed at the sleeve member 14, and the quick-release member 1342 is inserted into the lock portion 141. Specifically, the lock portion 141 includes a plug-in hole (not shown), and the quick-release member 1342 is plugged into the plug-in hole. In this embodiment, when the lock portion 141 is in a locked state, the quick-release member 1342 is locked in the lock portion 141, and the quick-release member 1342 is connected to the lock portion 141. When the lock portion 141 is in an unlocked state, the quick-release part 1342 is loosened from the lock portion 141, so that the quick-release member 1342 and the lock portion 141 are movably connected, which facilitates a separation of the quick-release member 1342 from the lock portion 141.

The sleeve 14 may further include an operation portion 142, and the operation portion 142 is configured to control the lock portion 141 to switch between a locked state and an unlocked state. The operation portion 142 is rotatably connected to the lock portion 141, and the lock portion 141 is controlled to switch between the locked state and the unlocked state by rotating the operation portion 142. In this embodiment, when the operation portion 142 rotates to a locked position, the lock portion 141 is in the locked state, so that the quick-release member 1342 can be locked in the lock portion 141 to implement a connection between the first shock-absorbing member 13 and the arm 2. When the operation portion 142 rotates to a unlocked position, the lock portion 141 is in the unlocked state, and the quick-release member 1342 and the lock portion 141 can be restored to an movable connection state, so that the first shock-absorbing member 13 can be dismounted from the arm 2. Specifically, during a rotation of the operation portion 142 from an unlocked position to the locked position, the insertion hole gradually decreases, thereby locking the quick-release member 1342. During the rotation of the operation portion 142 from the locked position to an unlocked position, the plug-in hole gradually increases, and finally the quick-release member 1342 is loosened from the plug-in hole to implement unlocking. A wrench may be selected as the operation portion 142. The wrench can be eccentrically connected to an outer side wall of the lock portion 141. With a rotation of the wrench being controlled, the wrench can be rotated to a locked position or an unlocked position, correspondingly, the lock portion 141 can be in a locked state or an unlocked state, and the quick-release member 1342 can be fixed to or separated from the lock portion 141.

It should be noted that the locked position and the unlocked position are two relatively opposite positions, but each are not limited to a certain point. In actual application, the locked position may also be a region where one of the quick-release members 1342 can be locked in the plug-in hole. Correspondingly, the unlocked position may also be another region where the quick-release member 1342 can be pulled out from the plug-in hole.

Also referring to FIG. 7, the second shock-absorbing structure 20 is located at least partially below the body 1. The gimbal 301 can be mounted to the UAV by connecting a part of the second shock-absorbing structure 20 below the body 1 to the gimbal 301 and the second shock-absorbing structure 20 can be used to damp the gimbal 301 disposed below the body 1. In this embodiment, the second shock-absorbing structure 20 may be a position limiting shock-absorbing mechanism. The gimbal 301 is mounted below the second shock-absorbing structure 20 and exerts a pulling force on the second shock-absorbing structure 20. The second shock-absorbing structure 20 can be configured to limit a position of the connection shaft 30 to prevent the connection shaft 30 from shaking, thereby preventing the gimbal 301 mounted below the second shock-absorbing structure 20 from shaking.

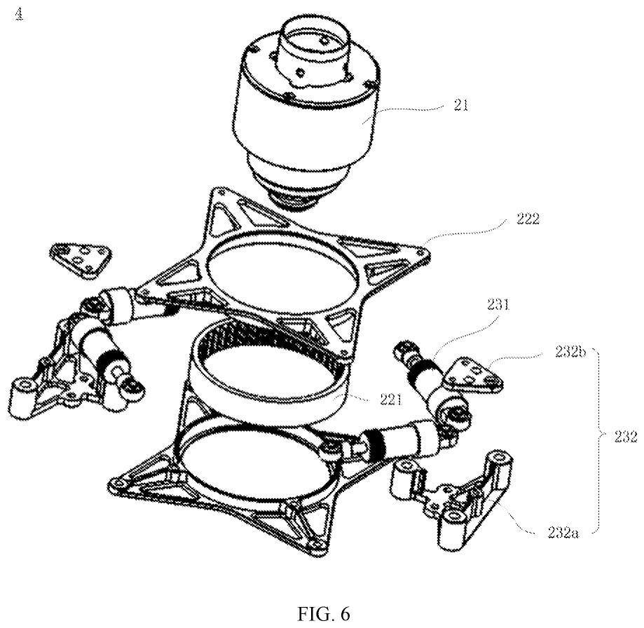

Referring to FIG. 6, the second shock-absorbing structure 20 may include a second mounting portion 21, a second support member 22, and a second shock-absorbing member 23. Optionally, the second mounting portion 21 is located below the body 1. Of course, the second support member 22 and the second shock-absorbing member 23 may also be located below the body 1, so that it can be more convenient to connect the second shock-absorbing structure 20 to the UAV.

The second mounting portion 21 can be configured to connect to the gimbal 301, so as to mount the gimbal 301 on top of the UAV. In this embodiment, the gimbal 301 and the second mounting portion 21 can be connected in a detachable manner. For example, the gimbal 301 and the second mounting portion 21 can be connected by a thread, a snap-fit, or other detachable connection manner, which facilitates the dismounting of the gimbal 301.

The second mounting portion 21 is further connected to the connection shaft 30 to support the second mounting portion 21 by the connection shaft 30. The connection manner between the second mounting portion 21 and the connection shaft 30 can be set based on needs. For example, in one embodiment, the second mounting portion 21 is sleeved with the connection shaft 30 and is connected to the connection shaft 30 by a thread, etc., thereby ensuring a stability of the second mounting portion 21, and the connection manner is simple and easy. In addition, the second mounting portion 21 may also be connected to the connection shaft 30 by a snap-fit, or other methods.

The second support member 22 may be configured to accommodate the second mounting portion 21, and the second shock-absorbing member 23 is disposed at an end of the second support member 22 away from the second mounting portion 21. The second shock-absorbing member 23 is configured to connect the body 1 of the UAV, so that the gimbal 301 can be mounted on top of the UAV by the second shock-absorbing structure 20. During the flight of the UAV, the mounted gimbal 301 swings (swings clockwise or counterclockwise along a circumferential direction the connection shaft 30) to drive the second mounting portion 21 to swing. The second mounting portion 21 may abut against the second support member during swinging, to facilitate the swinging of the second shock-absorbing member 23 and activate the second shock-absorbing member 23, thereby absorbing the shock of the gimbal 301.

Referring to FIG. 1 and FIG. 6, there may be a plurality of second shock-absorbing members 23 which are distributed around the second mounting portion 21, thereby limiting the position of the connection shaft 30, to prevent the upper-mounted gimbal 301 from shaking. Optionally, there are two second shock-absorbing members 23, which are symmetrically disposed on two sides of the connection shaft 30, respectively, so that the connection shaft 30 is fixed at a certain position between the two second shock-absorbing members 23.

The second support member 22 may include a bearing 221 and a second connection bracket 222. The bearing 221 is configured to accommodate the second mounting portion 21, the second connection bracket 222 is connected to the bearing 221, and a plurality of second shock-absorbing members 23 are connected around the second connection bracket 222. The second connection bracket 222 is configured to support the bearing 221 and the second shock-absorbing member 23, and can transmit a force from the bearing 221 to the second shock-absorbing member 23. During the flight of the UAV, the second mounting portion 21 swings under a drive of the gimbal 301, to abut against the bearing 221, and the bearing 221 is connected to the second shock-absorbing member 23, thereby implementing a damping function to the gimbal 301. The bearing 221 may be a sliding bearing or other type of bearing.

The type of the second shock-absorbing member 23 may also be selected based on the direction of the source of the shock. The second shock-absorbing member 23 may include at least one of: a one-dimensional shock absorber, a two-dimensional shock absorber, or a three-dimensional shock absorber. In a specific implementation, the second shock absorber 23 includes a compression shock absorber or a tension shock absorber, and is configured to apply an axial force perpendicular to the connection shaft 30 to the connection shaft 30, to limit the position of the connection shaft 30 on a horizontal plane by compressive force or tensile force, so that the position of the connection shaft 30 is always fixed, thereby preventing the connection shaft 30 from shaking and implementing the damping function to the gimbal 301 mounted underneath the UAV.

Specifically, each of the second shock-absorbing members 23 may include a second damper 231 disposed in pairs and a connection portion 232 configured to connect the body 1 of the UAV. The second dampers 231 disposed in pairs are rotatably connected to different positions of the second connection bracket 222 and are rotatably connected to the connection portion 232. In this embodiment, the second dampers 231 disposed in pairs can form a two-dimensional shock absorber, thereby counteracting the swinging of the connection shaft 30.

Referring again to FIG. 1, central axes of two second dampers 231 of the second dampers 231 disposed in pairs are perpendicular to each other, and the central axis of each second damper 231 is perpendicular to the connection shaft 30, to provide stiffness and damping for translation in the horizontal direction. This arrangement can improve the stability of the second shock-absorbing member 23. It should be noted that the arrangement manner of the second dampers 231 disposed in pairs are not limited to this, and the second dampers 231 disposed in pairs may be arranged in other ways to form a two-dimensional shock absorber. The arrangement of the second dampers 231 disposed in pairs is selected based on the stability requirements of the second shock-absorbing member 23. In addition, a number of the second dampers 231 of each second shock-absorbing member 23 is not limited to two, and may be two or more, as long as the second shock-absorbing member 23 can apply a force perpendicular to the axial direction of the connection shaft 30 to the connection shaft 30.

In this embodiment, the plane formed by the central axes of the two second dampers 231 of each second shock-absorbing member 23 is parallel to the plane formed by the central axes of the two second dampers 231 of another second shock-absorbing member 23, so as to limit the connection shaft 30 to a certain position in a region surrounded by a plurality of shock-absorbing members, to prevent the connection shaft 30 from shaking.

In addition, the connection portion 232 may include a main body portion 232a and a clamp portion 232b both connected to the body 1. The second damper 231 is rotatably clamped between the main body portion 232a and the clamp portion 232b, so as to achieve the fixation of the second shock-absorbing member 23 and the main body 1. The main body portion 232a can be fixed to the body 1 by a fixing member such as a screw. Optionally, at least three non-collinear positions of the main body portion 232 a are fixed to the body 1, so that the second shock-absorbing member 23 can be stably connected to the body 1. Of course, the connection position and connection manner of the main body portion 232a and the body 1 are not limited to this, and can be specifically set according to actual situations.

Referring also to FIG. 6, in this embodiment, there are two second connection brackets 222, and the two second connection brackets 222 are disposed apart from each other. The bearing 221 and one end of the second damper 231 are clamped between the two second connection brackets 222, to support the bearing 221 and the second damper by the two second connection brackets 222 that are spaced apart from each other.

The type of the second damper 231 can be selected based on needs. For example, a hydraulic viscous damper can be selected as the second damper 231.

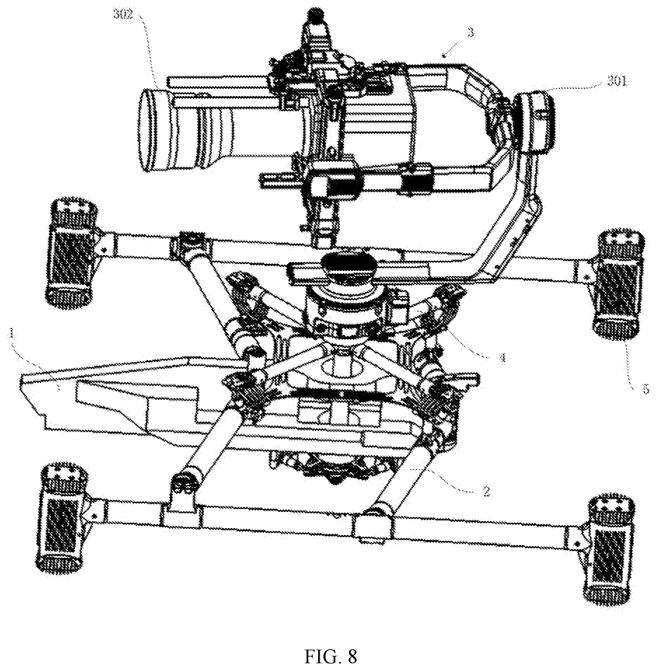

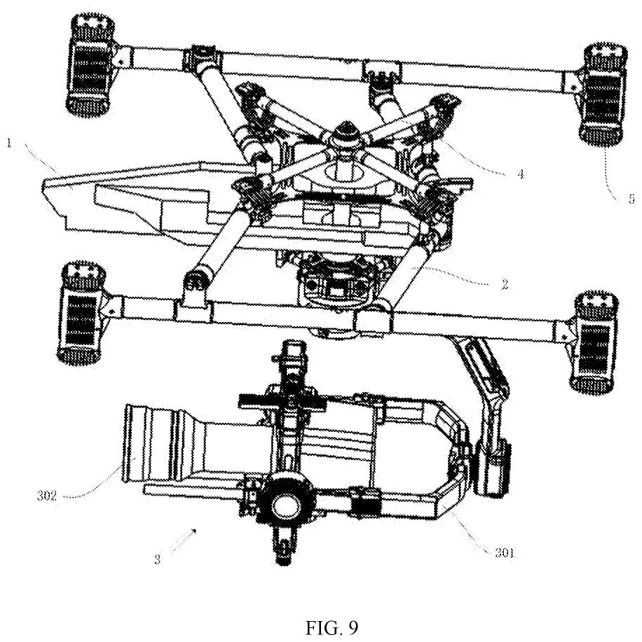

Referring to FIG. 8 and FIG. 9, the present disclosure further provides a gimbal assembly. The gimbal assembly may include a photographing device 3 and the above-mentioned damping device 4. The damping device 4 may connect the photographing device 3 to the UAV by the first-shock-absorbing structure 10, or connect the photographing device 3 to the UAV by the second shock-absorbing structure 20, to implement the damping function to the gimbal 301.

The photographing device 3 may include the gimbal 301 and the load 302 carried by the gimbal 301, and the gimbal 301 is connected to the first shock-absorbing structure 10 or the second shock-absorbing structure 20 to absorb the shock of the gimbal 301.

The load 302 can include a photographing apparatus such as a camera or an image sensor.

Referring to FIG. 8 and FIG. 9, the present disclosure further provides a UAV. The UAV may include the body 1, the arm 2 connected to the body 1, and the above-mentioned gimbal assembly.

The arm 2 may include a folding arm 201 connected to the body 1 and a straight arm 202 connected to the folding arm 201. Optionally, there are two straight arms 202, which are disposed in parallel on two sides of the body 1, respectively. At least two folding arms 201 are connected between each straight arm 202 and the body 1. One end of the folding arm 201 is connected to the body 1 and the other end is connected to the straight arm 202. The folding arm 201 is connected to the body 1 and the straight arm 202 in a movable connection manner, thereby facilitating the storage of the UAV. The damping device 4 can be connected to the folding arm 201 by the first shock-absorbing structure 10 thereon, to support the first shock-absorbing structure 10 by the folding arm 201, thereby connecting the gimbal 301 to the top of the UAV.

In addition, a propeller assembly 5 is connected to an end of the straight arm 202 away from the folding arm 201 to supply flying power to the UAV.

In the description of the present disclosure, “up,” “down,” “front,” “rear,” “left,” and “right” should be understood as “up,” “down,” “front,” “rear,” “left,” and “right” directions from top to bottom relative to the first mounting portion 11, the body 1, and the second mounting portion 21.

It should be noted that in the present disclosure, relational terms such as first and second are only used to distinguish one entity or operation from another entity or operation, and do not necessarily require or imply any such actual relationship or order between these entities or operations. The term “comprising,” “including” or any other variation thereof is intended to encompass non-exclusive inclusion, such that a process, method, article, or device that includes a series of elements includes not only those elements but also other elements that are not explicitly listed, or elements that are inherent in such a process, method, article, or device. Without further limitations, the use of “comprising a . . . ” in association with an element does not exclude the existence of other identical elements in the process, method, article, or device that includes the element.

The damping device, the gimbal assembly and the UAV having the damping device provided by the embodiments of the present disclosure, are described in detail above. Specific examples are used in the disclosure to explain the principle and implementation of the present disclosure. The descriptions of the above embodiments are only used to help to understand the method of the present disclosure and its core ideas. At the same time, those of ordinary skill in the art can make changes to the specific implementation and application scope based on the ideas of the present disclosure. In summary, the content of this specification should not be construed as a limitation to the present disclosure.

What is claimed is:

1. An unmanned aerial vehicle (UAV) comprising:
a body;
an arm connected to the body; and
a gimbal assembly including:
a gimbal;
a load carried by the gimbal; and
a damping device connecting the gimbal to the body, the damping device including:
a connection shaft configured to pass through the body; and
a first shock-absorbing structure and a second shock-absorbing structure disposed at two ends of the connection shaft, respectively;
wherein:
the first shock-absorbing structure is connected to the body or the arm;
the second shock-absorbing structure is connected to the body; and
one of the first shock-absorbing structure and the second shock-absorbing structure is connected to the gimbal.

2. The UAV according to claim 1, wherein the first shock-absorbing structure is located at least partially above the body and includes:
a mounting portion configured to be connected to the gimbal and the connection shaft;
a support member connected to the mounting portion; and
a shock-absorbing member disposed at an end of the support member away from the mounting portion and configured to be connected to the body or the arm.

3. The UAV according to claim 2, wherein:
the arm is one of a plurality of arms of the UAV;
the shock-absorbing member is one of a plurality of shock-absorbing members of the first shock-absorbing structure, the plurality of shock-absorbing members being configured to be correspondingly connected to the plurality of arms;
the support member is one of a plurality of support members of the first shock-absorbing structure, the plurality of support members being distributed around the mounting portion; and
each of the plurality of support members is connected to a corresponding one of the plurality of arms via a corresponding one of the plurality of shock-absorbing members.

4. The UAV according to claim 2, wherein:
the shock-absorbing member is one of a plurality of shock-absorbing members of the first shock-absorbing structure, the plurality of shock-absorbing members being configured to be correspondingly connected to the plurality of arms; and
the support member includes:
a plurality of connection rods connected to the mounting portion and distributed radially; and
a connection bracket disposed at one side of and spaced apart from the plurality of connection rods, each of the connection rods being connected to the connection bracket by a corresponding one of the plurality of shock-absorbing members.

5. The UAV according to claim 4, wherein each of the plurality of shock-absorbing member includes a composite shock absorber including two or more different types of shock absorbers.

6. The UAV according to claim 5, wherein one of the shock-absorbing members includes a steel wire rope and a damper, the steel wire rope and the damper being connected between a corresponding one of the connection rods and the connection bracket.

7. The UAV according to claim 6, wherein the steel wire rope and the damper are both inclinedly connected between the corresponding one of the connection rods and the connection bracket.

8. The UAV according to claim 6, wherein the steel wire rope is one of a plurality of steel wire ropes disposed in two rows opposite to each other, each of the two rows including one or more steel wire ropes bent in a direction away from the other one of the two rows.

9. The UAV according to claim 6, wherein the one of the shock-absorbing members further includes:
a first connection head configured to connect the steel wire rope and the damper to the corresponding one of the connection rods, the first connection head including:
a first fixation portion configured to fix the steel wire rope and the damper; and
a sleeve configured to sleeve the corresponding one of the connection rods; and
a second connection head configured to connect the steel wire rope and the damper to the connection bracket, the second connection head including:
a second fixation portion configured to fix the steel wire rope and the damper and connected to the connection bracket; and
a quick-release member connected to the second fixation portion and to a corresponding one of the arms.

10. The UAV according to claim 9, wherein:
the one of the shock-absorbing members further includes a first clamp member and a second clamp member corresponding to the first fixation portion and the second fixation portion, respectively;
one end of the steel wire rope is clamped between the first fixation portion and the first clamp member; and
another end of the steel wire rope is clamped between the second fixation portion and the second clamp member.

11. The UAV according to claim 9, wherein the damping device further includes a sleeve member movably connected to the quick-release member and configured to sleeve the corresponding one of the arms.

12. The UAV according to claim 11, wherein:
the sleeve member includes:
a lock portion, the quick-release member being inserted in the lock portion; and
an operation portion rotatably connected to the lock portion;
the lock portion is configured to be:
in a locked state to lock the quick-release member in response to the operation portion rotating to a locked position; and
in an unlocked state to unlock the quick-release member in response to the operation portion rotating to an unlocked position.

13. The UAV according to claim 9, wherein one end of the damper is rotatably connected to the first connection head and another end of the damper is rotatably connected to the second connection head.

14. The UAV according to claim 1, wherein the second shock-absorbing structure is located at least partially below the body and includes:
a mounting portion configured to be connected to the gimbal and the connection shaft, and
a support member accommodating the mounting portion; and
a shock-absorbing member disposed at an end of the support member away from the mounting portion and configured to be connected to the body.

15. The UAV according to claim 14, wherein the shock-absorbing member includes a compression shock absorber or a tension shock absorber configured to apply a force perpendicular to an axial direction of the connection shaft to the connection shaft.

16. The UAV according to claim 14, wherein the shock-absorbing member is one of a plurality of shock-absorbing members of the second shock-absorbing structure, the plurality of shock-absorbing members being distributed around the mounting portion.

17. The UAV according to claim 16, wherein the support member includes:
a bearing configured to accommodate the mounting portion; and
a connection bracket connected to the bearing, the plurality of shock-absorbing members being connected around the connection bracket.

18. The UAV according to claim 17, wherein the shock-absorbing member includes:
a connection portion configured to be connected to the body; and
two dampers rotatably connected to the connection bracket at different positions and rotatably connected to the connection portion, two center axes of the two dampers being perpendicular to each other, and the center axis of each of the two dampers being perpendicular to the connection shaft.

19. The UAV according to claim 18, wherein:
the connection bracket is one of two connection brackets spaced apart from each other; and
the bearing and one end of each of the two dampers are clamped between the two connection brackets.

20. The UAV according to claim 1, further comprising:
a propeller assembly;
wherein the arm includes:
a folding arm connected to the body, the damping device being connected to the folding arm via the first shock-absorbing structure; and
a straight arm connected to the folding arm, the propeller assembly being connected to an end of the straight arm away from the folding arm.
